(19) United States
(12) Patent Application Publication
(10) Pub. No.: US 2004/0054825 A1
(43) Pub. Date: Mar. 18, 2004

(54) Computer mouse conforming blue tooth protocol and having receiving capability and two output modules

(76) Inventor: Wen Chieh Wang, Taipei (TW)

Correspondence Address: Wen Chieh Wang, 235 Chung - Ho, Box 8-24, Taipei, TW

(21) Appl. No.: 10/244,917

(22) Filed: Sep. 17, 2002

(51) Int. Cl. G06F 13/12

(52) U.S. Cl. 710/62

(57) ABSTRACT

A computer mouse conforming blue tooth protocol and having receiving capability and two output modules comprises a mouse body built with a mouse module and a blue tooth communication module, an extending cable, a signal joint at a distal end of the cable and a hub control and I/O (input/output) port built with a data register and a switching control device for integrating the mouse module and the blue tooth communication module. The mouse module generating X axis and Y axis encoding outputs and the blue tooth communication module serves to receive and transmit wireless signals of standard blue tooth communication protocol. The blue tooth communication module is connected to the hub control and I/O port. Signals entering into the signal joint are transmitted through the blue tooth communication module.

### FIELD OF THE INVENTION

The present invention relates to computer mice, and particularly to a computer mouse conforming blue tooth protocol and having receiving capability and two output modules.

### BACKGROUND OF THE INVENTION

Computer mouse is an important computer peripheral device which is used in inputting/outputting data. In general, mouse is a wired device which is connected to the mainframe through a wire. However, this prior art design has strictly confined the application of the mouse since the moving range of the mouse is limited and thus it is inconvenient.

Wireless computer has become a popular trend in current electronic world. By wireless transmission, the data can be transferred from one device to another device without passing through wires. Recently, many electronic devices transfer data wirelessly. However, the current wired mouse can not be coupled to wireless devices. Thereby, the information of the mouse must be firstly sent to a computer through a wire and then is processed by the computer device. Nevertheless, the above said process is not economic and is time and labor-consumed.

Blue tooth communication protocol has been a popular communication protocol used in short range transmission, which is pushed firstly by Ercsson, Intel, IBM, Toshiba, Nokea, etc. in 1998 and now is widely accepted by many famous electronic companies. Thereby, there is an eager demand for a novel mouse device which is built with blue tooth communication function so as to communicate wirelessly.

### SUMMARY OF THE INVENTION

Accordingly, the primary object of the present invention is to provide a computer mouse conforming blue tooth protocol and having receiving capability and two output modules, wherein the blue tooth communication module is integrated to a mouse. Thereby, the mouse can transmit or receive wireless signals of blue tooth communication protocol and then the received signal can be sent to other computer device, and vice versa.

Another object of the present invention is to provide a computer mouse conforming blue tooth protocol and having receiving capability and two output modules, wherein the transmission objects can be addressed, encoded or encrypted so that the signals are sent to a selected device by identifying the address of the object. This design is especially suitable for being used in the office or in conference.

A further object of the present invention is to provide a computer mouse conforming blue tooth protocol and having receiving capability and two output modules, wherein the original mouse function is retained, and moreover, the mouse has the function of transmitting and receiving signals of blue tooth communication protocol. Thereby, the mouse has two output modules.

To achieve above objects, the present invention provides a computer mouse conforming blue tooth protocol and having receiving capability and two output modules. The computer mouse comprises a mouse body built with a mouse module and a blue tooth communication module, an extending cable, a signal joint at a distal end of the cable and a hub control and I/O (input/output) port built with a data register and a switching control device for integrating the mouse module and the blue tooth communication module. The mouse module generating X axis and Y axis encoding outputs and the blue tooth communication module serves to receive and transmit wireless signals of standard blue tooth communication protocol. The blue tooth communication module is connected to the hub control and I/O port. Signals entering into the signal joint are transmitted through the blue tooth communication module.

The various objects and advantages of the present invention will be more readily understood from the following detailed description when read in conjunction with the appended drawing.

### BRIEF DESCRIPTION OF THE DRAWINGS

FIG. 1 is a block diagram of the present invention.

FIG. 2 is a schematic view showing the arrangement of the mouse of the present invention.

FIG. 3 is a perspective view of the present invention.

FIG. 4 shows one embodiment of the present invention.

### DETAILED DESCRIPTION OF THE PREFERRED EMBODIMENTS

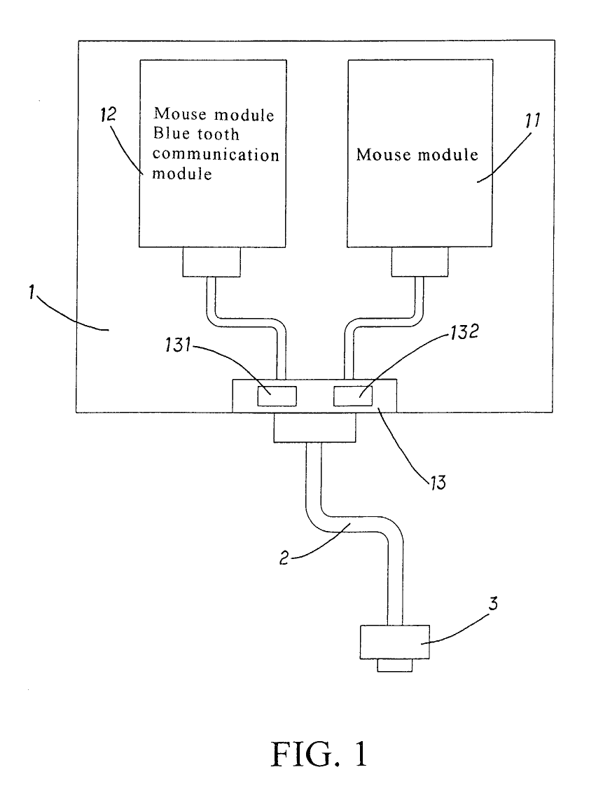

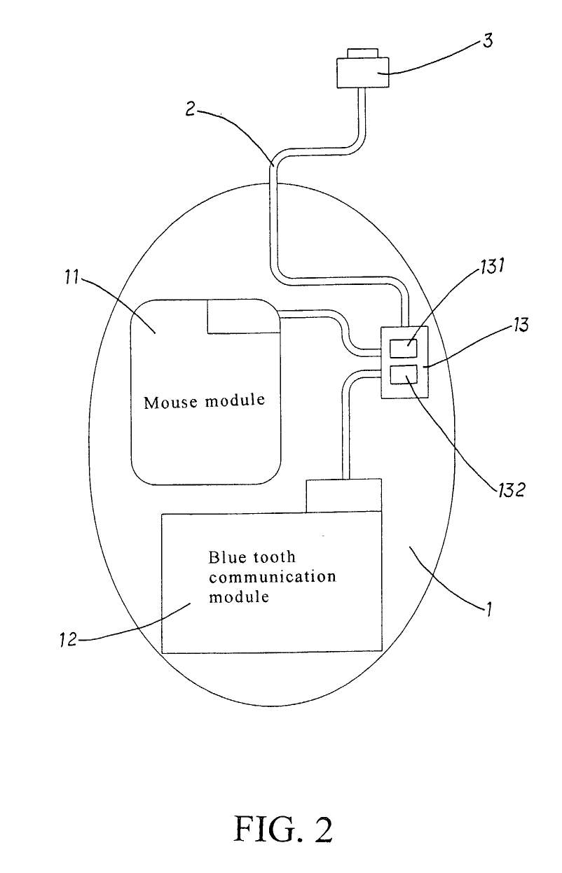

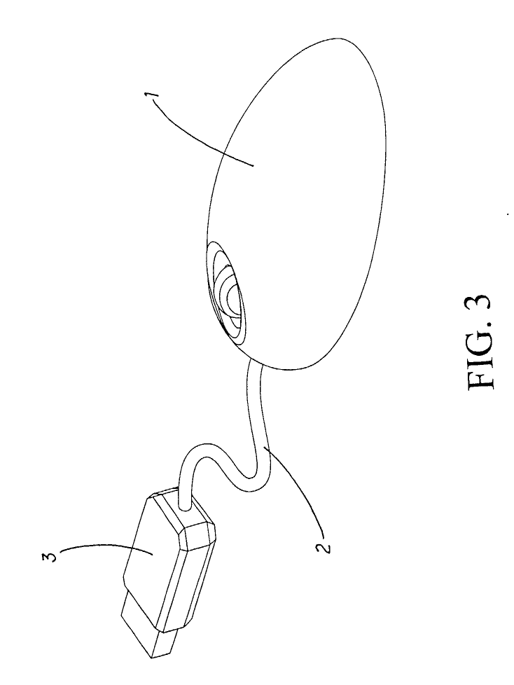

Referring to FIGS. 1 to 3, the computer mouse conforming blue tooth protocol and having receiving capability and two output modules of the present invention is illustrated. The mouse has a mouse body 1 built with a mouse module 11 and a blue tooth communication module 12, an extending cable 2, a signal joint 3 at a distal end of the cable 2 and a hub control and I/O port 13 built with a data register 131 and a switching control device 132 for integrating the mouse module 111 and the blue tooth communication module 12. The mouse module 11 can generate X axis and Y axis encoding outputs and the blue tooth communication module 12 serves to receive and transmit wireless signals of standard blue tooth communication protocol. The blue tooth communication module 12 is connected to the hub control and I/O port 13. The signals entering into the signal joint 3 are transmitted through the blue tooth communication module 12.

In the present invention, the signal joint at a distal end of the cable is a USB joint.

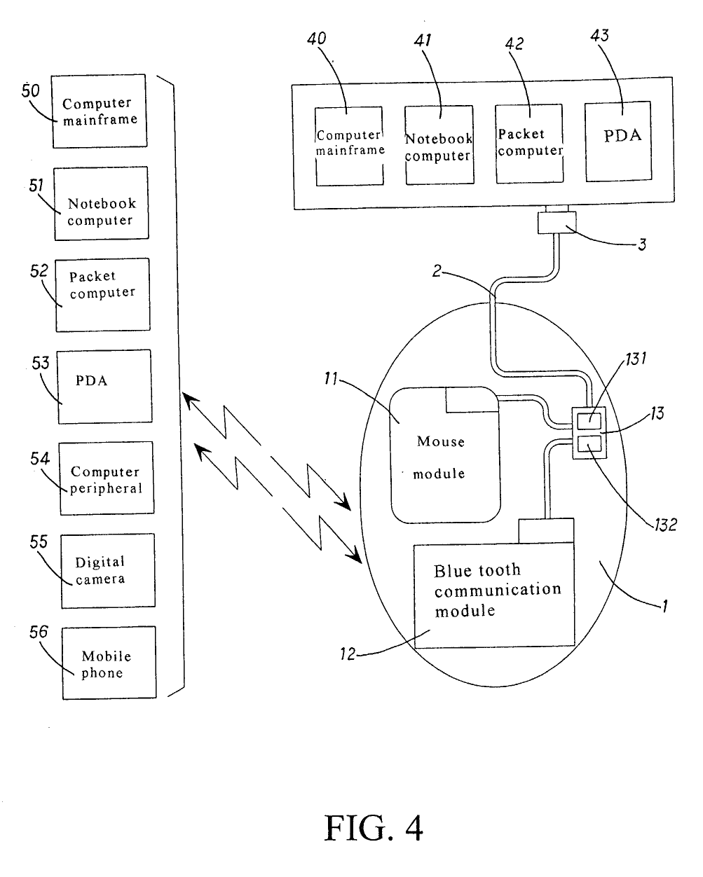

Referring to FIG. 4, one application of the present invention is illustrated. In this embodiment, the mechanism of the mouse is like an input and adapter element. The signal joint 3 at the distal end of cable 2 can be connected to a variety of computers, such as general used computer mainframes 40, notebook computers 41, packet computers 42 or personal digital assistants (PDA) 43. Thereby, the signal can be transmitted bi-directionally.

Moreover, the blue tooth communication module 12 may receive or transmit standard wireless signals of standard blue tooth communication protocol. The device for transmitting or receiving the wireless signals is one of a variety of computerdevices, such as a general computer mainframe 50, a notebook computer 51, a packet computer 52, or a personal digital assistant (PDA) 53, computer peripherals 54, for example, a printer, a mouse, etc., a digital camera 55 and a mobile phone 56, etc.

It is appreciated from above description that the present invention provides standard mouse function, and the blue tooth communication module 12 servers to transmit signals wirelessly using blue tooth communication protocol. Thereby, no wire is necessary. Moreover, the transmission object can be addressed, encoded or encrypted so that the signals can be sent to a selected device by identifying the address of the object. This design is especially suitable for being used in the office or in conference.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A computer mouse conforming blue tooth protocol and having receiving capability and two output modules comprising
a mouse body built with a mouse module and a blue tooth communication module,
a hub control and I/O (input/output) port built with a data register and a switching control device for integrating the mouse module and the blue tooth communication module;
a cable extending from the hub control and I/O port, and
a signal joint at a distal end of the cable;
wherein the mouse module generates X axis and Y axis encoding outputs and the blue tooth communication module serves to receive and transmit wireless signals of standard blue tooth communication protocol; the blue tooth communication module is connected to the hub control and I/O port; signals enter into the signal joint are transmitted through the blue tooth communication module.

2. The computer mouse conforming blue tooth protocol and having receiving capability and two output modules as claimed in claim 1, wherein the signal joint at a distal end of the cable is a USB joint.

3. The computer mouse conforming blue tooth protocol and having receiving capability and two output modules as claimed in claim 1, wherein the signal joint at a distal end of cable is connected to a computer device so that the signal is transmitted bi-directionally.

4. The computer mouse conforming blue tooth protocol and having receiving capability and two output modules as claimed in claim 3, wherein the computer device is selected from a group containing computer mainframes, notebook computers, packet computers or personal digital assistants.

5. The computer mouse conforming blue tooth protocol and having receiving capability and two output modules as claimed in claim 1, wherein the blue tooth communication module receives and transmits wireless signals of blue tooth communication protocol; and the device for transmitting and receiving the wireless signals is one of a variety of electronic device.

6. The computer mouse conforming blue tooth protocol and having receiving capability and two output modules as claimed in claim 5, wherein the electronic device is selected from a group containing computer mainframes, notebook computers, packet computers, personal digital assistants, and computer peripherals, printers, mice, digital cameras and mobile phones.

7. The computer mouse conforming blue tooth protocol and having receiving capability and two output modules as claimed in claim 1, wherein the hub control and I/O port is built with a data register.

8. The computer mouse conforming blue tooth protocol and having receiving capability and two output modules as claimed in claim 1, wherein the hub control and I/O port is installed with a switching control device for controlling data transferring path between the mouse module and the blue tooth communication module.
